(19) United States
(12) Patent Application Publication
(10) Pub. No.: US 2001/0044752 A1
(43) Pub. Date: Nov. 22, 2001

(54) Sales system and sales method for selling procucts by using the internet, and storage medium storing sales program

(76) Inventor: Tetsuya Hirakawa, Tokyo (JP)

Correspondence Address: SUGHRUE, MION, ZINN, MACPEAK & SEAS, 2100 Pennsylvania Avenue, N.W., Washington, DC, 20037-3202, US

(21) Appl. No.: 09/840,825

(22) Filed: Apr. 25, 2001

(30) Foreign Application Priority Data
May 17, 2000 (JP) 2000-145128

(51) Int. Cl. G06F 17/60

(52) U.S. Cl. 705/26

(57) ABSTRACT

The present invention aims at providing a sales system for selling products by using the Internet, by which occurrence of overheating price competition among suppliers selling the same product can be prevented.

The present invention comprises: upon receiving an application for purchasing a product provided by a supplier terminal 3 from a particular user terminal 1 via the Internet, charging a commission fee from the user terminal 1; randomly selecting a price of the product from a plurality of prices within a predetermined price range; and presenting the selected price on the user terminal 1 together with a predetermined term of validity. The user may purchase the product at the presented price, or may not purchase the product if (s)he does not agree with the presented price. By giving a price range to a single product from a single supplier, the price difference among the suppliers becomes difficult to tell, and thus overheating price competition among the stores can be avoided.

### FIELD OF THE INVENTION

The present invention relates to a sales system and a sales method for selling products by using the Internet and to a storage medium storing a sales program. More particularly, the present invention relates to a sales system, a sales method and a storage medium storing a sales program, which are characterized by the style of price presentation.

### BACKGROUND OF THE INVENTION

Recently, sales systems for selling products via the Internet have become common. According to such systems, pictures and prices of products are presented on an Internet site (homepage).

However, according to the conventional Internet-based sales systems, only a single selling price is usually set for a single product. Therefore, in order to purchase a cheaper product, the user, or the purchaser of the product, has to access a plurality of sites to collect information on the price of the product.

Furthermore, according to the conventional sales systems using the Internet, in order to promote the products to the purchasers, the product suppliers are often involved in price competition or a discount battle. Such a problem is likely to occur in the Internet-based sales system because the Internet allows easy comparison between the prices of the products from different suppliers.

Thus, the conventional sales system has a problem of causing overheating price competition between the suppliers.

The present invention has an objective of providing a sales system using the Internet, which can avoid an occurrence of overheating price competition between the suppliers selling the same product.

### SUMMARY OF THE INVENTION

In order to accomplish the above-mentioned objective, a sales system for selling a product by using the Internet according to the present invention comprises: a user terminal connected to the Internet; and a supplier terminal which, upon receiving an application for purchasing the product from the user terminal via the Internet, charges a commission fee from the user operating the user terminal, randomly selects a price of the product from a plurality of prices within a predetermined price range, and presents the selected price on the user terminal together with a predetermined term of validity.

According to the present invention, a selling price of a single product provided by a single supplier is included in a predetermined price range. As a result, a comparison between the selling prices from different suppliers becomes difficult, thereby preventing overheating price competition between the suppliers.

### BRIEF DESCRIPTION OF THE DRAWINGS

FIG. 1 is a block diagram showing a structure of a sales system using the Internet according to one embodiment of the present invention;

FIG. 2 is a flowchart illustrating an operation of the sales system using the Internet shown in FIG. 1; and

FIG. 3 is a graph representing the relationship between the selling prices and the product proportion.

### DETAILED DESCRIPTION OF THE INVENTION

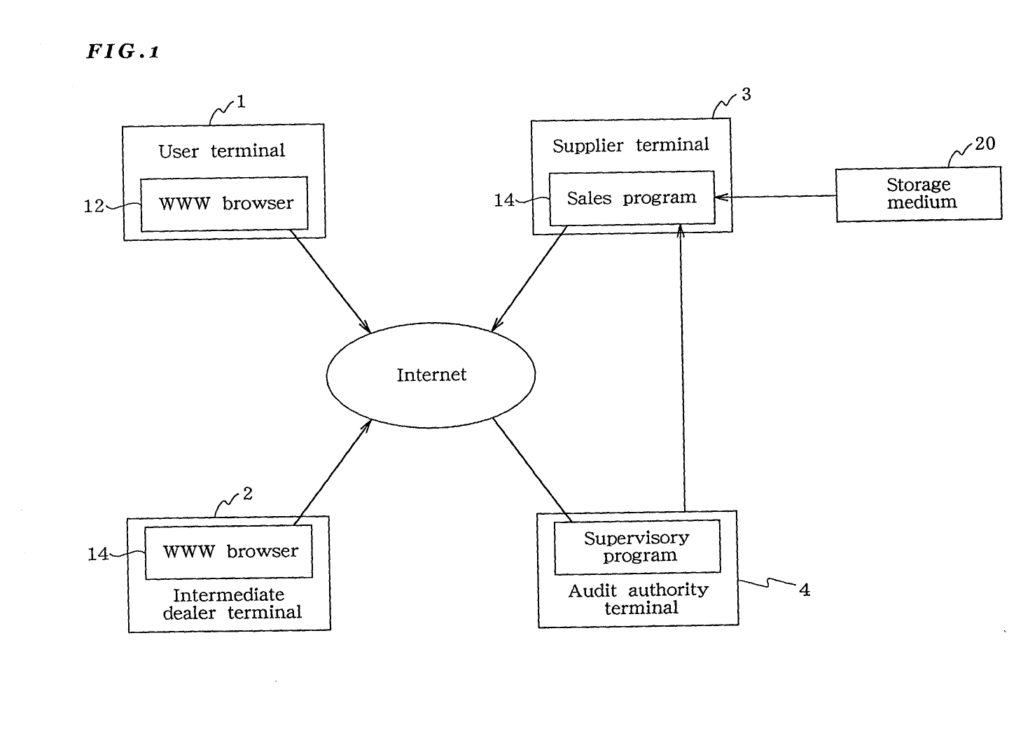

Hereinafter, one embodiment of the present invention will be described in detail with reference to the drawings. FIG. 1 is a block diagram showing a structure of a sales system using the Internet according to the embodiment of the present invention.

The Internet-based sales system according to this embodiment uses the existing Internet environment. A user terminal 1, an intermediate dealer terminal 2, a supplier terminal 3 and an audit authority terminal 4 are each connected to the Internet.

A sales program 11 is run on the supplier terminal 3, to determine selling prices and conduct merchandise control. The user terminal 1 and the intermediate dealer terminal 2 can use general WWW browsers 12 and 14 to participate in this sales system.

Hereinafter, purchasers of the products such as the users and the intermediate dealers are often collectively referred to as the “users”.

The audit authority terminal 4 performs direct online supervision of transactions between the user, the intermediate dealer and the supplier by adopting a supervisory program 13. Alternatively, indirect supervision is also possible by referring to the log file (past processing record) of the sales program 11.

The supplier terminal 3 is connected to a storage medium 20 storing the sales program 11 for executing the sales system according to the present embodiment. The storage medium 20 may be a magnetic disk, a semi-conductor disk or other storage medium. The sales program 11 is read out from the storage medium 20 by the supplier terminal 3 for controlling the operation of the supplier terminal 3. The supplier terminal 3 executes each processing according to the sales method of the present embodiment under the control of the sales program 11.

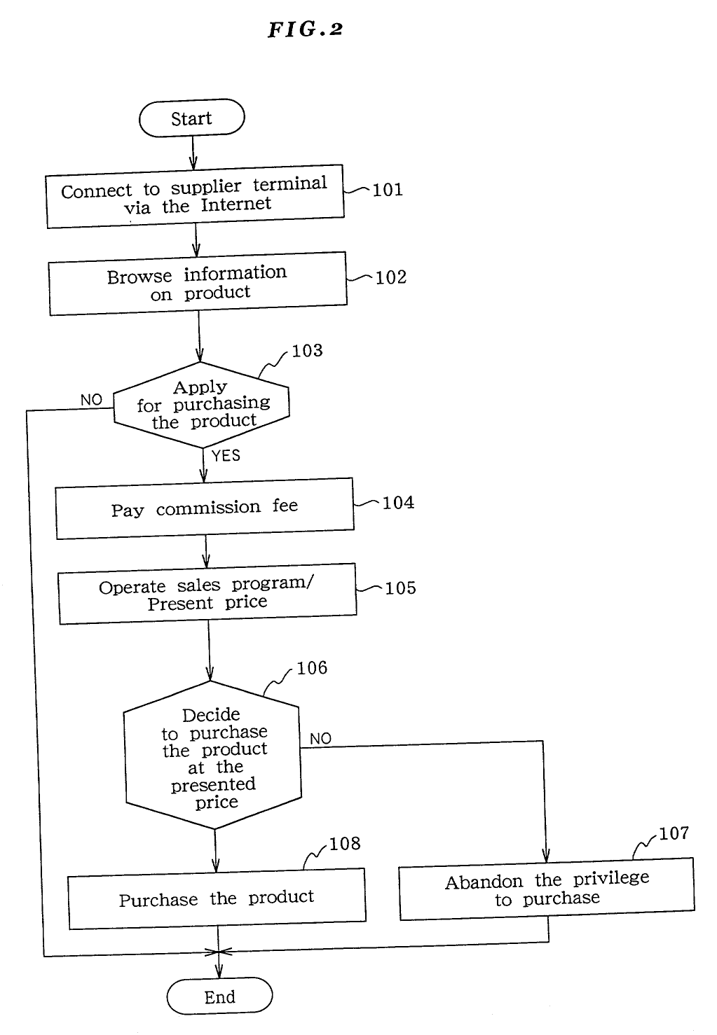

Hereinafter, an operation by the sales system of the present embodiment will be described with reference to a flowchart shown in FIG. 2.

For example, when a user desires to purchase a particular product, first (s)he uses the user terminal 1 to connect to the supplier terminal 3 via the Internet (Step 101). The user can find the information about the product upon connection to the supplier terminal 3. At this point, the information that can be confirmed by the user includes a standard price 21 and price history (changes of the price), which are recorded in the storage medium (Step 102).

In view of such product information, the user can apply for purchasing the product (Step 103). Upon this application, the supplier terminal 3 charges a commission fee of a few percent of the price of the applied product from the user in advance (Step 104). For example, if the standard price of the product is 10,000 yen and the commission rate is 1%, the user needs to pay 100 yen to the supplier.

Next, the sales program 11 is run on the supplier terminal 3 to randomly select the selling price of the product from a plurality of prices within a predetermined price range, and present the selected selling price on the user terminal 1. The possibility of each selling price to be selected is predetermined for each selling price.

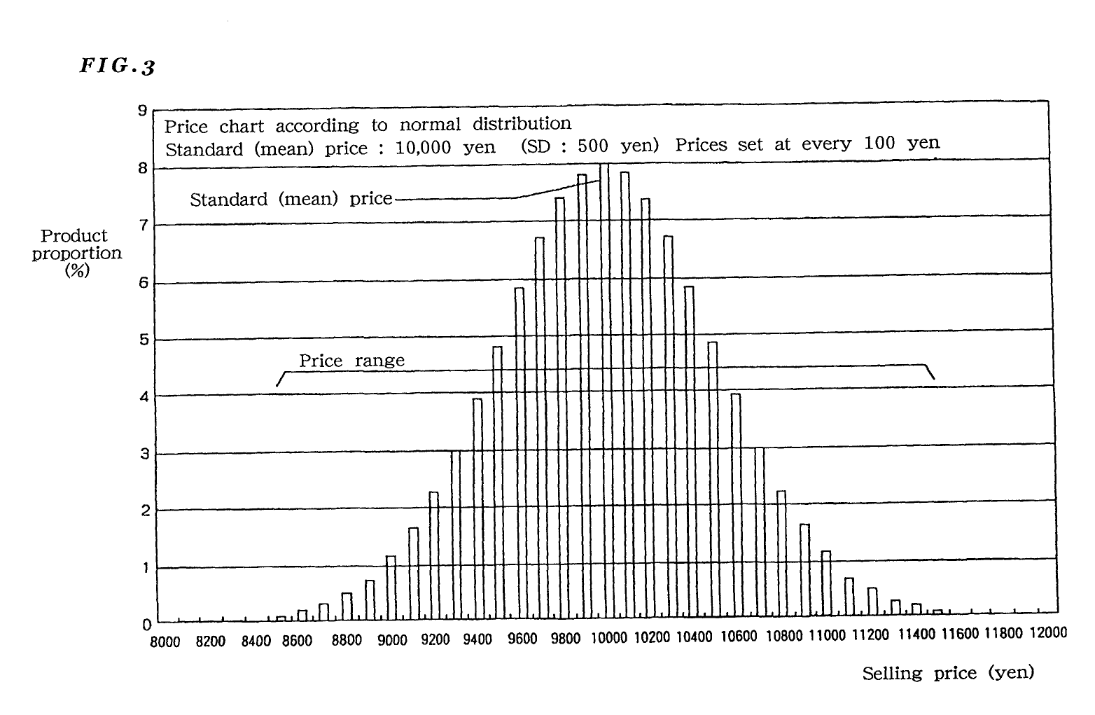

For example, if the standard price is 10,000 yen, the selling price may be selected from a price range of about 8,500 to 11,500 and then presented. An exemplary relationship between the selling price and the product proportion at each price will be shown in FIG. 3. In FIG. 3, the standard price is 10,000 yen (standard deviation: 500 yen), prices are set at every 100 yen, and product proportion at each price is set according to a normal distribution.

When the user decides to purchase the product at the presented price (Step 106), (s)he operates the user terminal 1 to purchase the product at the presented price (Step 108), thereby acquiring the privilege to purchase the product at the presented price. When the user desires to actually purchase the product, the supplier terminal 3 must sell the product at the presented selling price.

On the other hand, when the user considers that the presented price is too expensive (Step 106), (s)he can abandon the privilege to purchase the product without purchasing the product (Step 107). However, either the user decided to purchase or not to purchase the product, the commission fee paid in advance is not paid back. In other words, the user pays the commission fee to buy the privilege to purchase the product at the presented selling price.

In the above-described Step 106, when the user agrees with the selling price presented by the supplier terminal 3, (s)he can obtain the product upon payment to the supplier. However, the selling price has an expiration date, after which the user loses the privilege to buy the product at the presented selling price. For a general product, about one week would be enough as the term of validity.

Since the price of the product is not fixed according to the sales method of the present embodiment, it is possible that the supplier terminal 3 may conduct fraudulent operation. In order to prevent such fraud, a third-party audit authority is necessary for auditing the sales program 11, prices and the like. Accordingly, an audit authority terminal 4 is adopted to supervise the settings of the prices by the supplier terminal 3.

According to the sales system using the Internet of the present embodiment, as shown in FIG. 3, a product at a standard price of 10,000 yen can be sold with a price range of 3,000 yen. Therefore, the user has a chance of purchasing a product (s)he wishes for at a low price that would not be offered by a general sales method. The supplier can expect commission receipts. Even when the sales prices are slightly different between the suppliers, most of the prices should overlap by distributing the prices as represented by the graph shown in FIG. 3. Thus, it is difficult for the users to judge the difference of the prices between the suppliers. Judging which supplier sells the product at the most inexpensive price becomes particularly difficult when each supplier has a distinguishing price range, a distinguishing commission rate, a distinguishing product proportion or the like. As a result, overheating price competition between rival stores can be avoided. Even when the standard price is raised or reduced, such changes are hard for the user to recognize for the foresaid reason.

According to the sales system of the present embodiment, the settings of the sales program 11 can be changed to alter the sales feature. For example, the price range may be expanded to realize a game-like sales style like lottery instead of a normal sales style. Alternatively, by extending the term of validity for products whose prices unsteadily fluctuate, speculative purchasing can be realized.

Although the present embodiment is described as the case of direct purchasing by the users or the intermediate dealers, the present invention is not limited thereto. The users may acquire and then resell the privilege to purchase the product at the presented price if the privilege is no longer attractive to them.

The audit authority required by the system may not only supervise the sales transaction but may be entrusted by the supplier to be in full charge of the sales as a specialized agent employing the above-described sales method.

Thus, according to the present invention, a single product from a single supplier can be sold at a price within a predetermined range. As a result, it becomes difficult for the users to judge the difference of prices between the suppliers, thereby advantageously preventing price competition between the stores from overheating.

The invention may be embodied in other specific forms without departing from the spirit or essential characteristic thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

The entire disclosure of Japanese Patent Application No. 2000-145128 (Filed on May 17^{th}, 2000) including specification, claims, drawings and summary are incorporated herein by reference in its entirety.

What is to be claimed:

1. A sales system for selling a product by using the Internet, comprising:
a user terminal connected to the Internet; and
a supplier terminal which, upon receiving an application for purchasing the product from the user terminal via the Internet, charges a commission fee from the user operating the user terminal, randomly selects a price of the product from a plurality of prices within a predetermined price range, and presents the selected price on the user terminal together with a predetermined term of validity.

2. A sales system for selling a product by using the Internet according to claim 1, wherein the supplier terminal stores the standard price of the product, and the commission fee is determined by multiplying a predetermined rate to the standard price.

3. A sales system for selling a product by using the Internet according to claim 1, further comprising an audit authority terminal for supervising the settings of the prices by the supplier terminal.

4. A sales system for selling a product by using the Internet according to claims 1, further comprising a reselling function for reselling the privilege to purchase the product at the price presented by the supplier terminal to a third person.

5. A sales method for selling a product by using the Internet, comprising the steps of:
receiving an application for purchasing a product from a particular user terminal via the Internet;
charging a commission fee from the user operating the user terminal;
randomly selecting a price of the product from a plurality of prices within a predetermined price range; and
presenting the selected price on the user terminal together with a predetermined term of validity.

6. A sales method for selling a product by using the Internet according to claim 5, wherein the commission fee is determined by multiplying a predetermined rate to the standard price stored beforehand.

7. A storage medium storing a sales program for executing the processes comprising:
upon receiving an application for purchasing a product from a particular user terminal via the Internet, charging a commission fee from the user operating the user terminal;
randomly selecting a price of the product from a plurality of prices within a predetermined price range; and
presenting the selected price on the user terminal together with a predetermined term of validity.

8. A storage medium storing the sales program according to claim 7, wherein the process of charging the commission fee comprises multiplying a predetermined rate to the standard price stored beforehand.
